(19) United States
(12) Patent Application Publication
(10) Pub. No.: US 2004/0003017 A1
(43) Pub. Date: Jan. 1, 2004

(54) Method for performing complex number multiplication and fast fourier

(76) Inventors: Amit Dagan, Shimshit (IL); Gad S. Sheaffer, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/185,199

(22) Filed: Jun. 26, 2002

(51) Int. Cl. G06F 17/14; G06F 7/52

(52) U.S. Cl. 708/622; 708/404

(57) ABSTRACT

Multiplication of complex numbers is performed utilizing a single adder. A “mult_i” instruction includes a first subinstruction to perform a multiplication by +i to perform a first portion of a complex multiplication. Next, a second subinstruction calls a multiplication by −i, and the same adder is used to write results to an output register. The output register contains the results of the complex multiplication.

### FIELD

An embodiment of this invention relates to the field of computer systems and more particularly to a method for multiplying and adding complex numbers.

### BACKGROUND

Complex number multiplication is highly useful in many applications. For example, many communications devices, for example, modems, radar, television, and telephones, transmit data using both in-phase and quadrature signals. First and second complex numbers may take the form of a+ib and x+iy where a and b and x and y are real numbers and the coefficient i is the imaginary number √−1. The result of multiplying these first and second complex numbers is expressed in equation 1:

(a+ib)*(x+iy)=(a*x−b*y)+i(a*y+b*x). (1)

In order to perform this multiplication efficiently on a computer, different ways have been found to resolve the result in equation (1) into functions of the terms in the multipliers. A number of instructions have been created to produce those functions. For example, resolution of multiplication of a complex number by i into functions of a and b is shown in equation 2.

(a+ib)*(0+i)=(a*0−b*1)+i(a*1+b*0)=−b+ia (2)

In prior art, a multiply-accumulate instruction has been utilized with additional operations in order to produce an output in the form of the result of equation (1). More recently, multiplication of complex numbers has been successfully and efficiently achieved with creation of a new instruction, “multiply-add.” This instruction and known techniques for manipulating complex numbers to produce a result in the form of the multiplication result are described, for example, in commonly assigned U.S. Pat. No. 5,936,872 to Fischer, et al. issued Aug. 10, 1999. Depending on the instruction and operations used, performance may be slowed with respect to best available performance.

Another significant application of multiplying complex numbers is in the discrete Fourier transform (DFT) and its derivatives, such as the Fast Fourier Transform (FFT). The Fourier transform is a method, for example, to convert time domain input signals into the frequency domain. The Discrete Fourier Transform of discrete-time signals is widely used for spectrum analysis, voice recognition, fast computation of block filters, video compression and decompression and many other signal processing applications. In practice, the Fast Fourier Transform (FFT) is used as a practical matter because the DFT is too computationally intensive. The FFT itself is intensive in terms of the multiplications to be made. Various techniques such as data packing and the use of “single instruction multiple data” (SIMD) instructions have been utilized for parallel computations on a complex number expression. A more recent technique to speed processing is the use of radix complex FFT implementations. The definition of the discrete Fourier transform is shown in equation 3. The definitions of DFT is:

$$X ( k ) = {\sum }_{n = 0}^{N - 1} {x}_{n} {ⅇ}^{\frac{- ⅈ 2 π kn}{N}} \qquad ( 3 )$$

where N is the number of signal value samples. This expression must also be resolved into arithmetic operations. In radix-4 processing, n is a power of 4. The FFT divides the DFT into smaller DFTs if the division ratio is 2, the FFT is called radix-2. If the ratio is four, the FFT is called radix-4 and when the ratio is N, the FFT is called radix-N. Radix-4 requires more complex addressing and twiddle factors but also uses less computation. The twiddle factor is a complex coefficient. If extra computations are performed, processing will be slowed.

### BRIEF DESCRIPTION OF THE DRAWINGS

Embodiments of the invention are further understood by reference to the following description taken in connection with the following drawings:

Of the drawings:

FIG. 1 represents one form of a computer system incorporating an embodiment of the present invention;

FIG. 2 illustrates a register file of the processor in the computer of the embodiment of FIG. 1;

FIG. 3 is an illustration of operations to be performed in the present invention;

FIG. 4 is a further illustration of operation according to the present invention;

FIG. 5 is a block diagram further explaining the present invention; and

FIG. 6 is an illustration of a radix-4 butterfly executed by the present invention.

### DETAILED DESCRIPTION

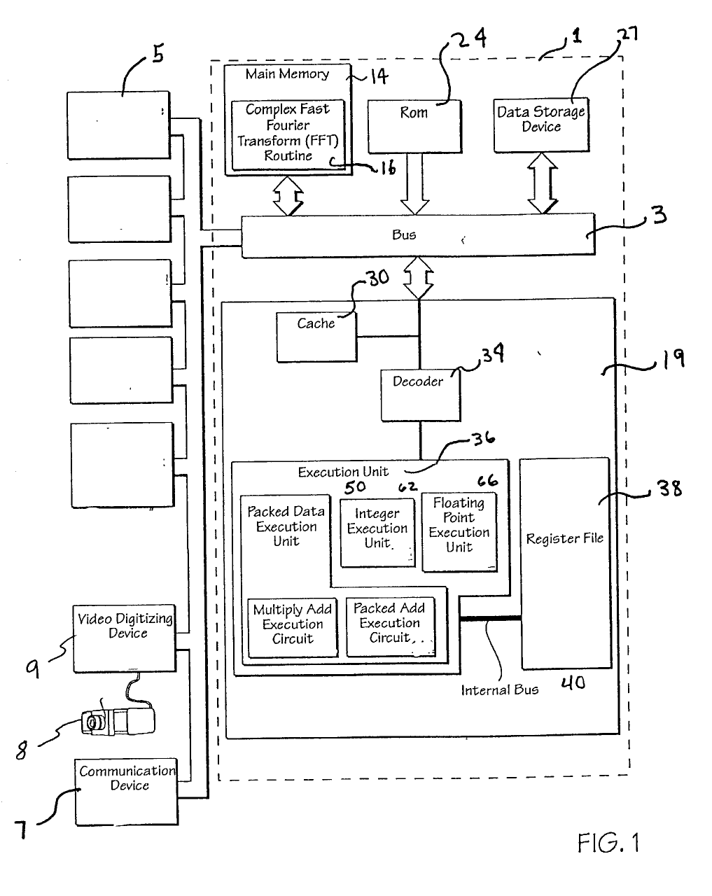

FIG. 1 is a block diagrammatic illustration of a computer system 1 communicating via a bus 3 to peripheral devices 5. These devices may include a communication device 7 providing signals for processing. A video camera 8 may provide inputs to a video digitizing device 9 connected to the bus 3.

The computer system 1 comprises a main memory 14. The main memory 14 will normally comprise random access memory (RAM) or another dynamic storage device. In the illustrated embodiment in which Fast Fourier Transforms will be calculated, the main memory 14 includes a complex Fast Fourier Transform program 16. The main memory 14 may also store twiddle factors, temporary variables or other intermediate information during execution of instructions by a processor 19. The processor 19 and main memory 14 communicate via the bus 3. A static storage memory 24 preferably comprises a read-only memory (ROM). Also connected to the bus 3 is a data storage device 27 which stores information and instructions. The processor 19 includes a cache 30, a decoder 34, an execution unit 36 and a register file 38. The execution unit 36 and register file 38 communicate via an internal bus 40. The register file 38 represents a data storage area on the processor 19 for storing information including data. The cache 30 caches data and/or control signals from, for example, the main memory 14. The decoder 34 decodes instructions received by the processor 19 into control signals or microcode entry points. In response to these control signals or microcode entry points, the execution unit 36 performs the appropriate operations. Any mechanism for logically performing instructed operations is comprehended by this description, whether serial or parallel in nature.

The execution unit 36 comprises a data execution unit 50 which includes units for performing selected operations on data. The data may be packed (for example, a 64-bit number may be operated upon in two 32-bit units)or unpacked. The execution unit 36 further includes an integer execution unit 62 and a floating point execution unit 66. The integer execution unit executes integer instructions. The floating point execution unit 66 will process the execution of floating point instructions. The computer system may be a terminal in a computer network such as a local area network (LAN)or a stand-alone PC, for example. In a preferred embodiment, the processor 19 supports an instruction set which is compatible with the Intel architecture instruction set used by existing processors (e.g. the Pentium® processor manufactured by Intel Corporation of Santa Clara, Calif.). In this embodiment, the processor 19 can support existing Intel architecture operations in addition to the operations provided by implementation embodiments of the invention. In the alternative, embodiments could incorporate other instruction sets and other architectures.

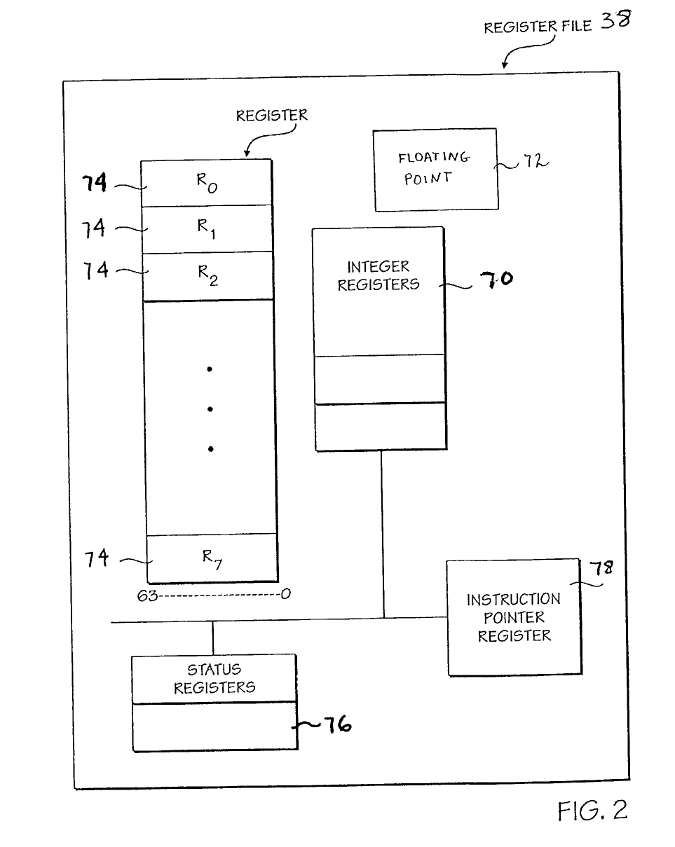

FIG. 2 is a more detailed block diagrammatic illustration of the register file 38 of FIG. 1. The register file 38 stores different types of information. These types of information include control/status information, integer data, floating point data and values being processed. In the present embodiment, the register file 38 includes integer registers 70, floating point registers 72, registers 74, status registers 76 and instruction pointer register 78. The processor 19 may operate on packed or unpacked data. Operations on packed data are well-known. For example, see the above-referenced U.S. Pat. No. 5,835,392. The processor 1 comprises machine-readable means for performing the method of embodiments of the present invention.

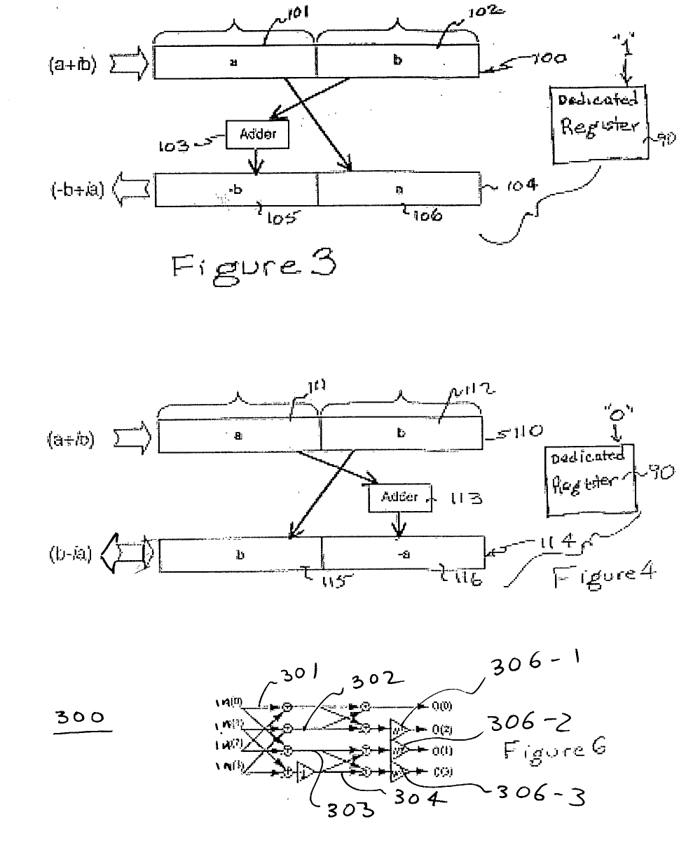

FIGS. 3 and 4 are diagrams representing elements of complex numbers to be multiplied and hardware performing multiplication. As discussed above, a multiplication of a complex number by a complex number has the form (restating equation (1)):

(a+ib)*(x−iy)=(a*x−b*y)+(ia*y+b*x)

This operation requires four multiply operations (a*x,b*y,a*y, and b*x)one addition (a*y+b*x)and one subtraction (a*x−b*y).

In order to multiply by both plus and minus i with one instruction, a “mult_i” instruction is introduced and utilized. The instruction whether to perform a complex multiplication by +i or −i can be constructed in different ways. In the first embodiment, two sub-instructions are invoked by the mult_i instruction to achieve the mult_i instruction. A first sub-instruction is mult_i_p to perform a multiplication by +i. A second sub-instruction is mult_i_n to perform a multiplication by −i. Alternatively, a single instruction mult_i may be used in conjunction with a dedicated control register. The control register stores an indicator so that when mult_i is called, a selected value of +i or −i will be utilized to perform the multiplication. For example, the dedicated register 90 (FIGS. 3 and 4) may supply a “1” to indicate a multiply by +i and a “0” to indicate a complex multiply by −i. Utilizing this instruction, a complex multiply by ±i is achieved while using only one adder to perform the operation.

When multiplying by +i, the complex multiplication is:

(a+ib)*(0+i)=(a*0−b*1)+i(a*1+b*0)=−b+ia.

When multiplying by −i, the complex multiplication is:

(a+ib)*(0−i)=(a*0−b*(−1))+i(a*(−1)+b*0)=b−ia.

The two parts of the complex number (a+ib) are accessed from the register 74 and held in one input buffer register 100. The buffer register has a real number location 101 and an imaginary number location 102.

FIG. 3 represents the complex multiplication when multiplying by +i. The term a+ib is multiplied by i. The coefficient of b, namely i when multiplied by i becomes −1. As indicated in the lower portion of FIG. 3, the value is negated using an adder 103. An adder as used in the present description comprehends any unit that performs negation. This applies to the adder 103 as well as adder 113 discussed below. The negated value (−b) is written to a real number section 105 of an output buffer register 104. The value a multiplied by i yields the result ia. The value a is written to an imaginary number location 106 of the output buffer register 104.

The illustration of multiplying the complex number by −i is shown in FIG. 4. The term a+ib when multiplied by −i becomes b−ia. Here, the terms a and ib are respectively loaded into real and imaginary locations 111 and 112 respectively of an input register 110. The value of a is negated using the adder 113, and the result (−a) is written into an imaginary number location 116 of an output register 114. The value b is written to a real number location 115 of the output buffer register 114. FIGS. 3 and 4 represent the sub-instructions multi_i_p and multi_i_n of the first embodiment. In the second embodiment, FIG. 3 represents the structure when a “1” is supplied to the dedicated register 90. FIG. 4 represents the connection of elements when a “0” is supplied to the dedicated register 90 on one form of the invention, the hardware performing both multiplications is the same circuit.

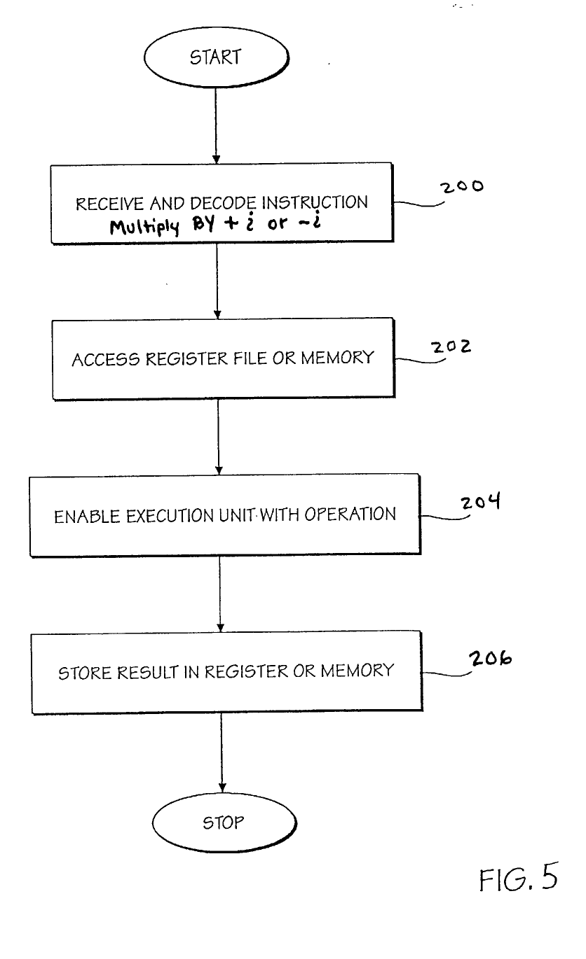

FIG. 5 is a flow chart illustrative of each multi instruction. At block 200, an instruction is provided, for example from the dedicated register 90 to determine whether a milti_i_p or multi_i_n operation will be performed. At block 202 a register file or memory location is accessed to provide values to the 101 and 102 of the input register 100 or to locations 111 and 112 of input register 110. The negative operation is performed in adder 103 or adder 113 as indicated at block 204. At block 206 values are written to the locations 105 and 106 of the output register 104 or to locations 115 and 116 of the output register 114. Values from the output register 104 or 114 may be written to the memory 14 (FIG. 1).

A significant application of the use of this improved instruction is in the Fast Fourier Transformation. As described above, the radix-4 FFT algorithm provides for efficient processing of the Fast Fourier Transform. FIG. 6 is an illustration of a complex radix-4 FFT butterfly stage 300, which is the computational core of the radix-4 algorithm. The mult_i instruction is applicable for any radix-N FFT algorithm (where N is a power of 2, greater than 2) and not only to radix-4. Butterfly stage 300 accepts inputs which are digitized signals or other input signals over data lines 301, 302, 303 and 304. By definition, since this is a radix-4 system, four sampled signals are being processed at a time.

The atomic operation of the radix-4 FFT algorithm takes four inputs, namely inputs in[0] through in[3], applied to the lines 301-304 respectively, and generates four outputs, namely out[0] through out[3] in the following manner:

Out[x]=in[0]+(−i)^{x}in[1]+(−1)^{x}in[2]+[i]^{x}in[3] where x=0, 1, 2, 3.

When extracting in the formula above:

Out[0]=in[0]+in[1]+in[2]+in[3]

Out[1]=in[0]+in[1]*(−i)−in[2]+in[3]*(i)

Out[2]=in[0]−in[1]+in2−in[3]

Out[3]=in[0]+in[1]*(i)−in[2]+in[3]*(−i)

In addition, out[1] through out[3] should be multiplied using a complex multiplier by a factor. The operation is done by operational blocks 306-1,306-2 and 306-3 in lines 302, 303 and 304 respectively.

By performing the multiplications in accordance with the method of FIG. 5, the hardware requirements to perform the atomic operation of the radix-4 algorithm are simplified. The savings of operations in performing the atomic radix-4 method per butterfly calculation is four real multiplications and one real add operation. Consequently, the number of real multiplications is decreased by 25 percent and the number of additions/subtractions is decreased by 6.52 percent. Such a great reduction provides many benefits. One such benefit is the opportunity to run at a lower frequency, consequently decreasing power requirements in portable, battery powered communications devices decrease in required power is extremely important.

What is thus provided are a method system and program product for providing highly efficient multiplication of complex numbers. Provision and use of the mult_i instruction is a significant element of performing a Fast Fourier Transform also. The specification has been written with a view to enable those skilled in the art to provide many embodiments of the present invention beyond the specific examples described above.

What is claimed is:

1. A method comprising: accessing a value indicative of a coefficient of one of a real or imaginary component of a complex number; negating the value in an arithmetic unit; and writing the negated value to a location indicative of the other of the real or imaginary component.

2. The method of claim 1 comprising: accessing a value from a location indicative of a coefficient i of the complex number; negating the value in the arithmetic unit; and writing the negated value to a location indicative of a value of a real component.

3. The method of claim 2 further comprising writing a value from a location indicative of a real number component to a location indicative of a value of a coefficient of i.

4. The method of claim 1 comprising: accessing a value indicative of a real number component and writing the value to a location indicative of a coefficient of i.

5. The method of claim 4 further comprising writing a value from a location indicative of a coefficient of i to a location indicative of a value of a real number component.

6. The method of claim 3 further comprising providing the complex number to multiply by i.

7. The method of claim 6 further providing a complex number to multiply by −i; accessing a value indicative of a real number component of the complex number to be multiplied by −i and writing the value to a location indicative of a coefficient of i; and a value from a location indicative of a coefficient of i of the complex number to be multiplied by −i to a location indicative of a value of a real number component.

8. The method of claim 7 wherein the provision of complex numbers comprises providing complex numbers in calculation of a Fast Fourier Transform.

9. The method of claim 8 wherein the fast Fourier transform is calculated as a radix-4 FFT algorithm having four inputs in[0] through in[3] and generating four outputs out [0] through out [3] having the form:
Out[x]=in[0]+(−i)^{x}in[1]+(−1)^{x}in[2]+[i]^{x}in[3]
where x=0, 1, 2, 3, and
when extracting in the formula above:
out[0]=in[0]+in[1]+in[2]+in[3]
out[1]=in[0]+in[1]*(−i)−in[2]+in[3]*(i)
out[2]−in[0]−in[1]+in2−in[3]
out[3]=in[0]+in[1]*(i)−in[2]+in[3]*(−i).

10. The method of claim 8 wherein the Fast Fourier Transform is calculated as a radix-N FFT algorithm having N inputs and generating N outputs, where N is a power of 2.

11. The method of claim 7 comprising performing the method of claim 7 in response to decoding of a single instruction.

12. The method of claim 3 comprising performing the method of claim 3 in response to decoding of a subinstruction of a single instruction.

13. The method of claim 5 comprising performing the method of claim 5 in response to decoding of a subinstruction of a single instruction.

14. A machine-readable medium that provides instructions which when executed by a processor causes said processor to perform operations comprising: accessing a value indicative of a coefficient of one of a real or imaginary component of a complex number; negating the value in an arithmetic unit; and writing the negated value to a location indicative of the other of the real or imaginary component.

15. The machine-readable medium of claim 14 wherein the operations comprise: accessing a value from a location indicative of a coefficient i of the complex number; negating the value in the arithmetic unit; and writing the negated value to a location indicative of a value of a real component.

16. The machine-readable medium of claim 14 wherein the operations further comprise: writing a value from a location indicative of a real number component to a location indicative of a value of a coefficient of i.

17. The machine-readable medium of claim 14 wherein the operations comprise: accessing a value indicative of a real number component and writing the value to a location indicative of a coefficient of i.

18. The machine-readable medium of claim 16 wherein the operations further comprise: writing a value from a location indicative of a coefficient of i to a location indicative of a value of a real number component.

19. The machine-readable medium of claim 15 wherein the operations further comprise providing the complex number to multiply by i.

20. The machine-readable medium of claim 18 wherein the operations further comprise: providing a complex number to multiply by −i; accessing a value indicative of a real number component of the complex number to be multiplied by −i and writing the value to a location indicative of a coefficient of i; and a value from a location indicative of a coefficient of i of the complex number to be multiplied by −i to a location indicative of a value of a real number component.

21. A processor comprising: a complex number input buffer register to store a real component of a complex number in a first location and an imaginary component of the complex number in a second location, an arithmetic unit to negate a component and a complex number output buffer register comprising a first location for storing a real component of a complex number and a second location for storing an imaginary component of a complex number, said arithmetic unit being connectable between said input buffer register and said output buffer register to negate a value from a first or second location of the input buffer register and write to the second or first location respectively of the output buffer register.

22. The processor of claim 20 further comprising interconnection for writing a value of the component not negated by said arithmetic unit to a remaining location in said output buffer register.

23. The processor of claim 20 wherein multiplication is performed by i and said arithmetic unit is coupled between said second location of said input buffer register and said first location of said output buffer register.

24. The processor of claim 20 wherein multiplication is performed by −i and said arithmetic unit is coupled between said first location of said input buffer register and said second location of said output buffer register.
